(19) United States
(12) Patent Application Publication
(10) Pub. No.: US 2017/0318122 A1
(43) Pub. Date: Nov. 2, 2017

(54) BUSINESS OBJECT INFORMATION SHARING METHOD AND APPARATUS

(71) Applicant: Alibaba Group Holding Limited, Grand Cayman (KY)

(72) Inventors: Xueting Jiang, Hangzhou (CN); Zuomang Xiong, Zhejiang (CN); Xinheng Fan, Zhejiang (CN)

(21) Appl. No.: 15/654,521

(22) Filed: Jul. 19, 2017

Related U.S. Application Data
(63) Continuation of application No. PCT/CN2016/070165, filed on Jan. 5, 2016.

(30) Foreign Application Priority Data
Jan. 19, 2015 (CN) 201510026079.X

(51) Int. Cl. H04L 29/08; G01S 5/00

(52) U.S. Cl. CPC H04L 67/327; G01S 5/0009; H04L 67/2814

(57) ABSTRACT

Information sharing methods and apparatuses are disclosed. A request for information sharing is sent by a requesting client terminal and is received at a server; a geographic position of the requesting client terminal is determined; an associated client terminal is identified based on a geographic proximity to the requesting client terminal; and an information sharing session is implemented between the requesting client terminal and the associated client terminal.

This disclosure claims priority from and is a continuation of PCT Patent Application No. PCT/CN2016/070165, filed on 5 Jan. 2016, which claims priority from Chinese Patent Application No. 201510026079.X, filed on 19 Jan. 2015, entitled “Business Object Information Sharing Method and Apparatus,” which are all hereby incorporated by reference in their entirety.

### TECHNICAL FIELD

The present application relates generally to data communication, and particularly, to content sharing between client terminals.

### BACKGROUND

With the continuous improvements of data communication, more streamed contents are available to users. At the meanwhile, searching for the pertinent contents becomes more challenging and time consuming. Thus, it is desirable to effectively share among users the pertinent contents. For example, user A may desire to share with user B a content displayed on user A's mobile phone such that user B can view the same content on her own device without additional searching. For a more specific illustrative example, a user may recommend a restaurant to others through sharing the on-line information of the restaurant.

Conventionally, an instant communication tool and existing association relationship are needed for both sides of such information/content sharing. If one (or more) of the users does not have the same instant communication tool installed on her device, or if one (or more) of the users does not identify/register the other(s) as associated, content/information sharing cannot be achieved using the conventional solutions. Further, in a case that the instant communication tool is a third-party tool, addition constraints on the content/information sharing may be applied by the third-party tool. For example, a URL link to the to-be-shared content may be blocked by a third-party instant communication tool.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment.

FIG. 2 illustrates an example application server.

FIG. 3 illustrates an example client terminal.

FIG. 4 illustrates an example operation process.

FIG. 5 illustrates another example operation process.

FIG. 6 illustrates an example scenario of gesture inputs.

### DETAILED DESCRIPTION

### 1. Overview

Embodiments of the present disclosure provide an information/content sharing method(s) and system(s)/device(s), which can effectuate content/information sharing between/among identified geographically associated users conveniently and efficiently.

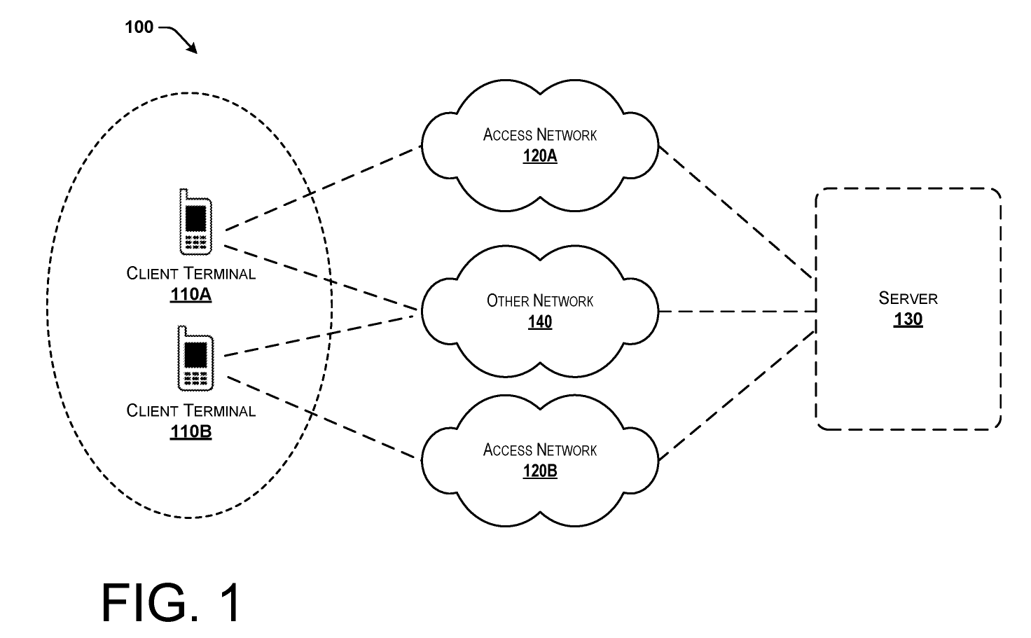

With reference to FIG. 1, example content sharing may be achieved through interactions between/among relevant users through their client terminals 110A and 110B, and an application server(s) 130. Each client terminal 110A, 110B may include a client terminal application installed thereon, or may, in the course of a content sharing operation, be prompted to install computer executable instructions to implement the client terminal application, e.g., by downloading the computer executable instructions from a server, e.g., application server 130. A client terminal application on client terminals 110A, 110B may include both software and hardware components and may function with both the software and hardware components. In the disclosure herein, a client terminal and a client terminal application thereof may be referred to interchangeably, and may both be referred to with numerals 110A, 110B (or generally numeral 110), respectively, which should not affect the scope of the disclosure. Further, some or all components of the client terminal(s) 110 may reside on a relevant user device locally or may reside on a remote server (not shown for simplicity) in a cloud based computing architecture and may function with local components of the client terminal(s) 110.

With client terminal(s) 110A, 110B in operation, a user may provide an input onto the relevant client terminal 110, e.g., client terminal 110A, to initiate a request for content sharing with a different user (client terminal 110), e.g., client terminal 110B, identifiable based on a geographical pointer. In the description herein, the client terminal, e.g., 110A, that initiates the request may be referred to as a requesting client terminal 110 for description purposes and the client terminal, e.g., 110B, identified based on the geographic pointer may be referred to as an associated client terminal 110 for description purposes. A geographic pointer may be any geographic information that identifies a client terminal 110 and all are included in the disclosure. For example, a geographic pointer may include a geographic proximity to the requesting client terminal 110. A geographic pointer may also include a reference position estimate of the associated client terminal, e.g., client terminal 110B, involved in the requested content sharing. A reference position estimate may include an estimated distance and/or a relative direction of the associated client terminal 110 to the requesting client terminal 110. A geographic pointer may also include specific geographic coordinates of a client terminal 110. Further multiple geographic pointers may function together or may be fully or partially overlapping. For example, a reference position estimate may be used to help determine a geographic proximity.

The input may be in any forms and all are included. For example, the input may include a gesture or a voice command detectable by a client terminal 110A, 110B as, among others, indicating an initiation of a request for content sharing. For an illustrative example, a gesture input on a client terminal 110, e.g., 110A, may include a finger(s) pointing to a displayed content and then waving/sliding to a relative direction. The content pointed to may be identified as the to-be-shared content and the waving/sliding may be identified as indicating a geographic pointer, e.g., a relative direction of associated client terminal, e.g., 110B, relative to the requesting client terminal 110A.

With the input detected, the requesting client terminal 110A may generate a request for content sharing. The request for content sharing may include a time stamp indicating a time point at which the input is detected. The time stamp may alternatively or additionally indicate other time points, e.g., a time point when the request for content sharing is generated or a time point when the request for sharing is sent to server 130, etc.

The request of content sharing may also include an identification of the to-be-shared content, if any, and/or the geographical position information of the requesting client terminal 110A, if any. There are various approaches a client terminal 110 may determine its own geographical position, e.g., through an embedded global positioning system (GPS) sensor, and the client terminal 110 may include such available geographic position information in the generated request for content/information sharing.

The requesting client terminal 110A may send the generated request for content sharing to application server 130. A client terminal 110A, 110B may communicate with server 130 through relative access networks 120A, 120B, e.g., wireless telecommunication networks. It is possible that either one or both of the users of client terminals 110A, 110B involved in the content sharing may initiate a request for content sharing. That is, either a user who is supposed to share a content (here, for illustrative example, user of client terminal 110A) or a user who is supposed to receive the shared content (here, for illustrative example, user of client terminal 110B) may initiate the request for sharing. In a scenario that both users of client terminal 110A and client terminal 110B input to their user devices to initiate requests, one of the requests, e.g., the request with an earlier time stamp or the request received earlier by the server, may be referred to as an initiative request, and the other request may be referred to as a responsive request, for descriptive purposes only. For the description herein, for simplicity of illustration, it is assumed that client terminal 110A send an initiative request for content sharing and client terminal 110B sends, if any, a responsive request for content sharing.

Any content/information available to be shared between client terminals 110 may be possible and all are included in the disclosure and none will limit the scope of the disclosure.

Upon receiving a request (e.g., an initiative request) for content sharing from requesting client terminal 110A, server 130 may determine a geographic position of the requesting client terminal 110A. A geographic position of a client terminal 110 may include a horizontal position and/or a vertical position and may include an outdoor position and/or an indoor position. Server 130 may obtain the geographic position of requesting client terminal 110A from the request for content sharing itself, e.g., if the request includes such information, and/or may determine the geographic position of client terminal 110A from other channels/approaches. Any indoor/outdoor positioning techniques may be used to determine a geographic position of a client terminal 110A, 110B, and all are included in the disclosure. For example, a satellite based positioning, a sensor based positioning, and/or a wireless signal strength based positioning technique may be used to determine geographic position of a client terminal 110. Server 130 may coordinate with a client terminal 110 to determine the geographic position thereof and/or may determine the geographic position of a client terminal 110 without the client terminal 110 being involved. Server 130 may obtain the determined geographic positions of client terminals 110 through a separate network, e.g., other network 140, other than the access networks 120A, 120B that client terminals 110A, 110B communicate with server 130.

Considering that client terminals 110 are movable, the determination of the geographic position of a requesting client terminal 110A may consider the timeliness of the determined geographic position with respect to the received request for content sharing. For example, server 130 may determine a position(s) of requesting client terminal 110A of the initiative request for content sharing within a time range about the time stamp of the initiative request. The time range, referred to as “first time range” for illustrative purposes, may be pre-determined, dynamically determined and/or may be customizable.

Based on the determined geographic position of requesting client terminal 110A, server 130 may identify an associated client terminal 110 based on a geographic pointer. The geographic pointer may be determined based on a system set up of sever 130 or may be based on the relevant request for content sharing, or may be determined based on a combination of the two. For example, a geographic proximity to requesting client terminal 110A may be used as a geographic pointer. A threshold distance may be used to determine the geographic proximity. The threshold distance may be set up by server 130 and/or may be indicated by the relevant request. For an illustrative example, a request for content sharing may indicate that a content will be shared with an associated client terminal 110 within a half meter circle of the requesting client terminal 110A. Then the threshold distance may be set up at about half meter. Further, a relative direction to the requesting client terminal 110, e.g., 110A, may also be used as a geographic pointer, which may be included in the request. Furthermore, a request may provide specific geographic coordinates (i.e., geographic position) of an associated client terminal 110 involved in the content sharing, which could be used as a geographic pointer for server 130 to identify the associated client terminal 110.

The identifying an associated client terminal 110 based on a determined geographic pointer may include determining a geographic position of the associated client terminal. For example, server 130 may periodically collect/determine position information of client terminals 110 and update and/or save the collected/determined position information of a client terminal 110 for a certain period of time. Such saved position information of client terminals 110 may be retrieved to identify the associated client terminal(s) 110 based on the geographic pointer(s). For another example, in the case that server 130 receives multiple requests for content sharing, server 130 may match the multiple requests based on their relevant geographic pointers to identify client terminals 110 relevant to a same content sharing effort, i.e., those of an initiative request for content sharing and a responsive request for content sharing.

Similar to determining the geographic position of requesting client terminal 110A, the identifying of an associated client terminals 110 based on a geographic pointer, e.g., client terminal 110B in a geographic proximity to client terminal 110A, may be performed for a time range (referred to as “second time range”) about the time stamp of the request. The second time range may be set up as the same as the first time range (i.e., fully overlapping with the first time range) or may be different.

In an example, for a candidate/potential associated client terminal 110, e.g., client terminal 110B, server 130 may determine the geographic position thereof multiple times within the second time range to determine, e.g., whether the client terminal 110 stays relatively stable within the second time range about the time stamp of the relevant request for content sharing. The reasons include that if a client terminal 110 keeps moving and just by accident comes into geographic proximity to requesting client terminal 110A, such client terminal 110 is not likely to be involved in the content sharing with requesting client terminal 110A.

After server 130 determines one or more client terminals 110, e.g., client terminal 110B, as associated to requesting client terminal 110A based on the geographic pointer(s), e.g., in geographic proximity to client terminal 110A, server 130 may send to client terminal 110A and/or the identified associated client terminal(s) 110B a prompt message for them to confirm the requested content sharing. In an example, the confirmation process may include an authentication operation for security purposes. Any authentication measures may be used and all are included in the disclosure. For example, server 130 may send an encrypted element to requesting client terminal 110A to be presented to the nearby client terminal 110 involved in the content sharing to decrypt and server 130 may send a key to the identified associated client terminal 110B to perform the decryption. If the identified associated client terminal 110B is not the client terminal 110 involved in the content sharing with requesting client terminal 110A, client terminal 110B will not be presented with the encrypted element to decrypt and will not succeed the authentication. This way, for example, only the client terminal 110 with which requesting client terminal 110A is willing to share content can obtain the decrypted element to effectuate the content sharing.

Upon confirmation by at least one of requesting client terminal 110A and associated client terminal 110B identified by server 130 on the requested content sharing, sever 130 may implement an information/content sharing session between requesting client terminal 110A and associated client terminal 110B based on the request. For example, server 130 may identify, based on the request (initiative request and/or responsive request), if any, a source of the to-be-shared content/information, and cause to present the content/information on associated client terminal 110B. For example, server 130 may identify a Uniform Resource Locator (URL) link to a to-be-shared content and send the URL link to associated client terminal 110B.

It should be appreciated that an initiative request for content sharing may not come from a client terminal 110 that is sharing the content. It is possible that client terminal 110A sends an initiative request for content sharing which essentially indicates that client terminal 110A is ready to receive a to-be-shared content from associated client terminal 110B, and it may be the responsive request and/or confirmation message from client terminal 110B that includes the identification information of the to-be-shared content. Other approaches to identify a to-be-shared content/information and to implement the content/information sharing are also possible and included in the disclosure.

### 2. Example Devices

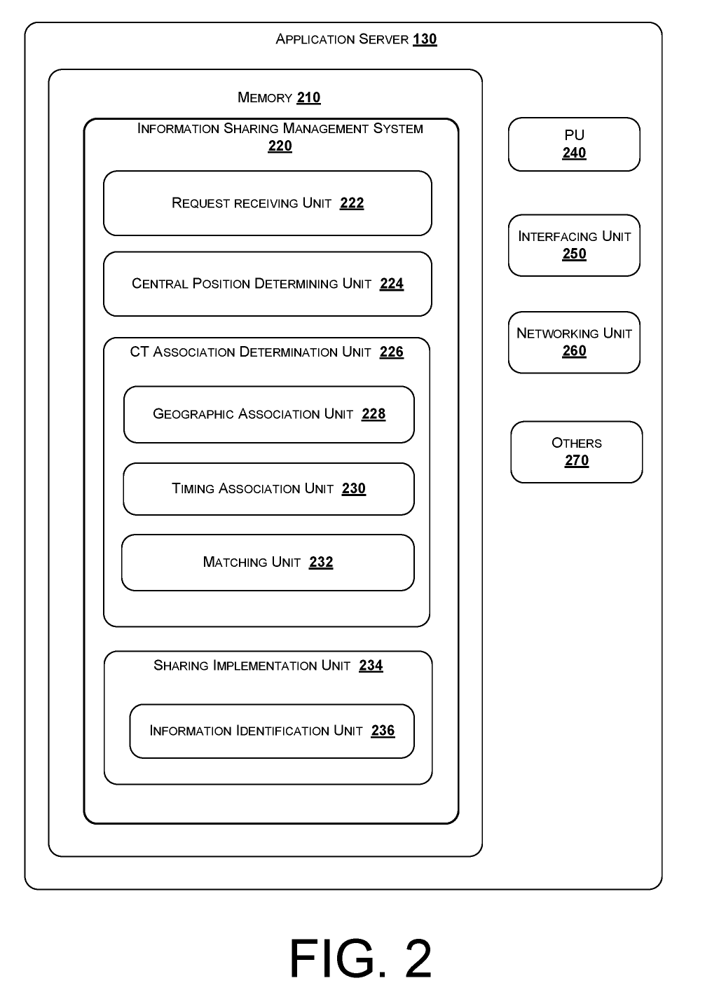

FIG. 2 illustrates elements of an example application server 130. As shown in FIG. 2, application server 130 may include a memory (memories) 210 containing computer executable instructions which, when executed by a processing unit, configures the processing unit to implement an information sharing management system 220. Information sharing management system 220 may include a request receiving unit 222, a central position determination unit 224, a client terminal (CT) association determination unit 226 and a sharing implementation unit 234. CT association determination unit 226 may further include a geographic association unit 228, a timing association unit 230, and a matching unit 232. Sharing implementation unit 234 may further include an information identification unit 236.

Application server 130 may also include a processing unit(s) (PU) 240, an interfacing unit(s) 250, a networking unit(s) 260 and other components 270.

It should be appreciated that units of application server 130 may reside on a single computing device or on multiple computing devices linked in a distributed computing environment/system, and all are included in the disclosure. Details of a computing device or a distributed computing environment/system is not required to understand the disclosure and do not limit the scope of the disclosure.

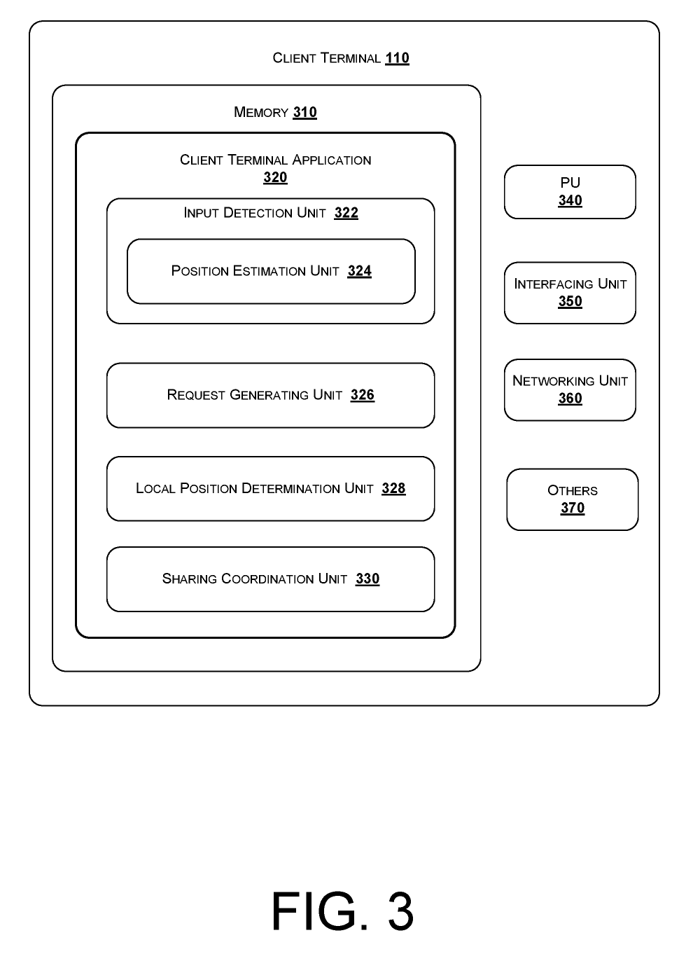

FIG. 3 illustrates elements of client terminal 110. As shown in FIG. 3, client terminal 110 may include a memory (memories) 310 containing computer executable instructions which, when executed by a processing unit, configures the processing unit to implement a client terminal application 320. Client terminal application 320 may include an input detection unit 322 including a position estimation unit 324, a request generation unit 326, a local position determination unit 328 and a sharing coordination unit 330.

Client terminal 110 may also include a processing unit(s) (PU) 340, an interfacing unit(s) 350, a networking unit(s) 360 and other components 370.

It should be appreciated that example client terminal 110 as shown in FIG. 3 may implement a requesting client terminal 110A and/or an associated client terminal 110B.

Referring to FIGS. 2 and 3 together, in operation, input detection unit 322 of requesting client terminal 110 may be configured to identify an input for initiating information sharing. The input identifying may include detecting an input onto requesting client terminal 110, and/or may include determining that the detected input is for the purpose of initiating information sharing. For example, upon detecting an input, input detection unit 322 may cause to present a modal dialog requiring a confirmation that the input is for information sharing.

In an example, in a case that a requesting client terminal 110 is to share a content/information in the requested information sharing, the input identifying may include detecting a gesture operation identifying a piece of information displayed on a display of the client terminal as the to-be-shared information.

To make the input detection process more vivid and intuitive, and to improve user experience, in an example, an interactive animation effect may be used in the input detection. For example, after a gesture input on a displayed content of client terminal 110A, the content may be presented with a “floating” effect, and the “floating” content may move with the sliding/swinging gesture.

Position estimation unit 324 may be configured to determine, from the identified input, a reference position estimate of associated client terminal 110 involved in the content sharing. Based on the settings of requesting client terminal 110, various reference position estimates may be possible and all are included in the disclosure. For example, a detected gesture may indicate a relative direction of the associated client terminal 110B relative to the requesting client terminal 110A. For example, a gesture input may include a finger(s) pointing to a displayed information and then sliding to a direction. The direction (relative direction) may indicate where the associated client terminal 110B is positioned relative to the requesting client terminal 110A, which may be determined as a reference position estimate. The input may also indicate that the associated client terminal 110B is within one meter distance to the requesting client terminal 110A, which may be determined as a reference position estimate.

Request generation unit 326 may be configured to generate, based on the identified input, a request for information sharing. The request for information sharing may include a time stamp indicating a time point of identifying the input. It should be appreciated that the time stamp does not necessarily be exactly the time point when the input is identified. The time stamp may be the time point when the input data is recorded, the time point when the request is generated, or the time point when the generated request is scheduled to be sent to server 130. Given the speedy nature of processing the input and generating the request, all of the above identified example time stamps are able to indicate the time point of the input identifying and are all included in the disclosure. Other ways to time stamp a generated request to indicate the time point of identifying the input are also possible and included.

The generated request may further include at least one of an identification of a piece of information to be shared by the requesting client terminal 110 (in the case that the request is generated by an information sharing client terminal 110) or an indication of being available to receive a piece of information, e.g., readiness/availability to receive shared information (in the case that the request is generated by information receiving client terminal 110), under the information sharing.

Further, in the case that position estimate unit 324 determines a reference position estimate of associated client terminal 110 involved in the requested information sharing, the generated request may also include the determined reference position estimate.

Local position determination unit 328 may be configured to determine a geographic position of client terminal 110 within a first time range about the time stamp of the generated request. Any approaches may be used in determining the geographic position of client terminal 110 and all are included in the disclosure. For example, local position determination unit 328 may use one or more of a satellite based positioning (e.g., a GPS based positioning), a sensor based positioning (e.g., a sensor based indoor positioning), and/or a radio frequency signal based positioning (e.g., a positioning based on wireless signal strength).

In an example, the request for content/information sharing generated by request generation unit 326 may include the geographic position of the requesting client terminal 110 determined by local position determination unit 328. It should be appreciated that it is possible that the request may include multiple locally determined geographic positions of the requesting client terminal 110 and the respective time points of the position determination to facilitate the processing of the request by server 130 and for sever 130 to finally determine a position of client terminal 110 with respect to the relevant request for content sharing.

Request receiving unit 222 of sever 130 may be configured to receive a request for information sharing, e.g., an initiative request, from a requesting client terminal 110. The receiving may be through various communication networks and all are included. For example, the request may be received through a third-party access network 120 or may be through server 130's proprietary network 140. In an example, upon receiving a request for content sharing, request receiving unit 222 may assign a time stamp to the received request in addition to or instead of the time stamp included in the request, if any.

Central position determination unit 224 may be configured to determine a geographic position of a client terminal 110 within a time range about a time stamp of a request for content/information sharing. The client terminal(s) 110 may be a requesting client terminal 110 (either initiative request or responsive request) or a client terminal 110 that does not send any request but are potentially involved based on geographic pointers related to a request for content sharing, i.e., potential/candidate associated client terminal 110.

For each request for content sharing (initiative or responsive), central position determination unit 224 may determine a geographic position of the requesting client terminal 110 within a time range (first time range) about the time stamp of the request. And central position determination unit 224 may determine geographic positions of other client terminals 110 that are potentially involved in the request within another time range (second time range) about the time stamp of the request. The first time range and the second time range may or may not fully overlap with one another.

Client terminal (CT) association determination unit 226 may be configured to identify a client terminal 110 as associated with a requesting client terminal 110 based on a geographic pointer. In an example, a geographic proximity to the requesting client terminal may be used as a geographic pointer and client terminal (CT) association determination unit 226 may identify a client terminal 110 in a geographic proximity to the requesting client terminal 110 within the second time range about the time stamp of the request.

Specifically, geographic association unit 228 may be configured to determine a potential/candidate associated client terminal 110 based on a geographic pointer. For example, geographic association unit 228 may determine potential associated client terminals 110 based on a geographic proximity to the requesting client terminal 110. The geographic proximity may be determined, based on, a threshold distance. For example, if a determined geographic position of a client terminal 110 (e.g., by central position determination unit 224) is within the threshold distance to the requesting client terminal 110, geographic association unit 228 may determine that the client terminal 110 is in geographic proximity to the requesting client terminal 110 and is potentially geographical associated to the requesting client terminal 110. It should be appreciated that geographic association unit 228 may determine the geographic proximity in the three-dimensional positioning coordinates and consider both the longitude and the latitude coordinates of a client terminal 110.

Geographic association unit 228 may also use the reference position estimate included in the request for content sharing as a geographic pointer. For example, if the request for content sharing includes a relative direction of the associated client terminal 110 to the requesting client terminal 110 as a reference position estimate, geographic association unit 228 may determine client terminals 110 positioned in the relative direction as potentially associated client terminals 110. It should be appreciated that geographic association unit 228 may use multiple geographic pointers in determining the geographic association, e.g., geographic proximity. For example, a distance to the requesting client terminal 110 and a relative direction to the requesting client terminal 110 may be used together to determine an associated client terminal 110.

Timing association unit 230 may be configured to determine that a client terminal 110 is associated with the requesting client terminal 110 within a second time range about the time stamp of the relevant request for content sharing. If a client terminal 110 is geographically associated with the requesting client terminal 110 outside the second time range about the time stamp of the request, timing association unit 230 may not determine the client terminal 110 as a potential associated client terminal 110.

For example, server 130 may regularly obtain position information of client terminals 110. With respect to a specific request for content sharing, timing association unit 230 may identify the position information of client terminals 110 within the second time range about the time stamp of the specific request. In another example, timing association unit 230 may cause central position determining unit 224 to determine position information of client terminals 110 within the second time range about the time stamp of the specific request. Other approaches of determining associations of client terminals 110 within the second time range about the time stamp of the request is also possible and included in the disclosure.

Matching unit 232 may be configured to match an initiative request and a responsive request to determine an association between the requesting client terminals of the initiative request and the responsive request. For example, server 130, specifically, request receiving unit 22, may receive many requests for content sharing within a set time interval, and each request may be either an initiative request or a responsive request. Matching unit 232 may match each of these received requests with others to try find the association, i.e., the initiative request and the responsive request involved in a same requested content sharing.

Matching unit 232 may implement the matching based on the time stamps of the requests. For example, matching unit 232 may set a threshold window in time stamps and may identify requests with time stamps sufficiently close to one another, i.e., within the threshold window, as potentially associated.

Matching unit 232 may also implement the matching based on the reference position estimates included in each requests. For example, if the relative directions (an example of reference position estimate) included in two requests point to one another, matching unit 232 may identify the requesting client terminals 110 of the two requests as potentially associated. In the case that two client terminals 110 each sends a request for content sharing (an initiative request and a responsive request), each of the two client terminals 110 is a requesting client terminal with respect to its own request and is an associated client terminal with respect to the other's request.

In an example, two or more of geographic association unit 228, timing association unit 230 and matching unit 232 may work with one another in determining an association between the requesting client terminal 110 and an associated client terminal 110.

In an example, CT association determination unit 226 may send the determined association (potential/candidate association) to at least one of the relevant requesting client terminal 110 and associated client terminal 110 for them to confirm that they are willing to conduct the requested content sharing with one another. In an example, the confirmation from the associated client terminal 110 may be treated as a responsive request.

Sharing implementation unit 234 may be configured to implement an information/content sharing session between the requesting client terminal 110 and the associated client terminal 110. Specifically, information identification unit 236 may be configured to identify the to-be-shared content/information. Information identification unit 236 may obtain an identification of the to-be-shared content/information from at least one of the initiative request and the responsive request including the confirmation from the associated client terminal 110, if any. Information identification unit 236 may also coordinate with at least one of the requesting client terminal 110 or the associated client terminal 110 to obtain the identification of the to-be-shared content/information. Other approaches to identify the to-be-shared information/content is also possible and included.

Upon identifying the to-be-shared information, sharing implementation unit 234 may coordinate with sharing coordination unit 330 of the client terminal 110 supposed to receive the to-be-shared content/information to implement the sharing. For illustrative example, sharing implementation unit 234 may send a URL link of the to-be-shared content/information to the client terminal 110 and the sharing coordination unit 330 of the client terminal may display the webpage content directed to by the URL.

### 3. Example Processes

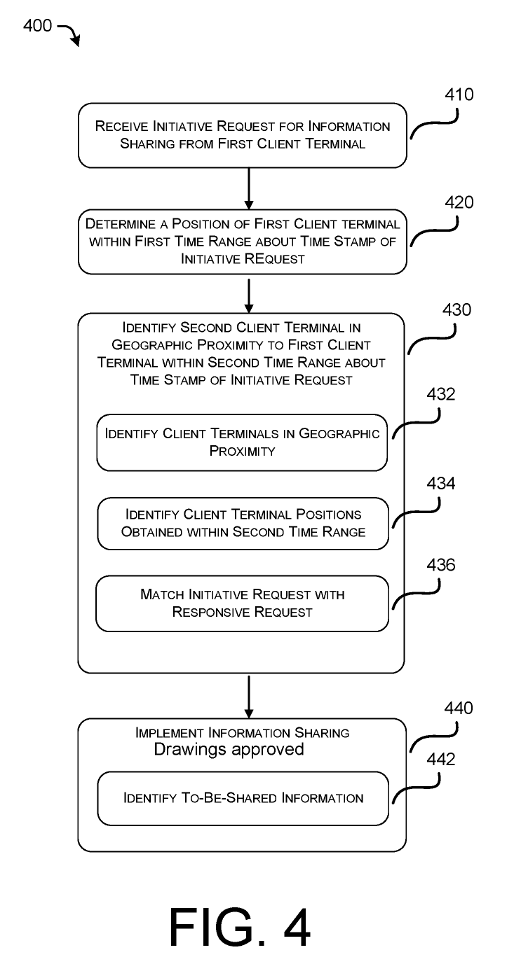

FIG. 4 shows an example operation process of application server 130. In the description of FIG. 4, example scenarios of client terminal 110A being a requesting client terminal of an initiative request (e.g., a request with an earlier time stamp) and client terminal 110B being a requesting client terminal of a responsive request (e.g., a request with a later time stamp) are referred to for illustrative purposes.

With reference to FIG. 4, in example operation 410, request receiving unit 222 of sever 130 may receive an initiative request for content sharing from a client terminal 110A. The initiative request may include a first time stamp, and/or request receiving unit 22 may assign a first time stamp to the received request upon receiving. The assigned time stamp may indicate when the request is received. Information sharing management system 220 may be set to use either one of the time stamp included in the request or the assigned time stamp or both in the processing of the request.

Request receiving unit 222 of sever 130 may also receive a responsive request for content sharing from client terminal 110B. The responsive request may includes a second time stamp and/or may be assigned a second time stamp. It should be appreciated that at request receiving unit 222, server 130 does not know that the initiative request and the responsive request and the respective client terminals 110A, 110B are associated with one another. With the two requests received, server 130 may perform substantially the same operations on each of the initiative request and the responsive request. For simplicity, the description herein use the initiative request as illustrative examples to describe the example operation process.

In example operation 420, central position determination unit 224 may determine a geographic position of client terminal 110A within a first time range about a time stamp of the initiative request for content/information sharing.

In example operation 430, Client terminal (CT) association determination unit 226 may identify a client terminal 110B as associated with a requesting client terminal 110A based on a geographic pointer. In an example, a geographic proximity to the requesting client terminal 110A may be used as a geographic pointer and client terminal (CT) association determination unit 226 may identify client terminal 110B as positioned in a geographic proximity to requesting client terminal 110A within the second time range about the time stamp of the request.

Specifically, in example sub-operation 432, geographic association unit 228 may identify client terminal 110B as positioned in geographic proximity to requesting client terminal 110A. The geographic positions of client terminal 110B may be obtained by central position determination unit 224 in various manners. In an example, central position determination unit 224 may determine the geographic positions of client terminal 110B based on a same positioning technology as in determining the geographic position of the requesting client terminal 110A so that to minimize the systematic errors caused by different positioning techniques.

In example sub-operation 434, timing association unit 230 may identify client terminal 110 positions obtained within the second time range about the time stamp of the request of requesting client terminal 110A. For illustrative example, timing association unit 230 may identify that client terminal 110B include geographic positions obtained within the second time range.

With the results of sub-operations 432 and 434 together, it may be determined that a geographic position of client terminal 110B obtained within the second time range is in a geographic proximity to requesting client terminal 110A. Consequently, client terminal 110B may be determined as an associated client terminal 110 to the requesting client terminal 110A for the request for content sharing (initiative request) of client terminal 110A.

The same operation may be conducted on the request for content sharing (responsive request) of client terminal 110B and it may be determined that client terminal 110A is an associated client terminal 110 to the requesting client terminal 110B for the responsive request thereof.

In example sub-operation 436, matching unit 232 may match an initiative request and a responsive request to determine an association between the relevant requesting client terminals 110 of the initiative request and the responsive request. It should be appreciated there might be scenarios that for a requested content sharing, there is only an initiative request and there is no responsive request. It should also be appreciated that server 130 may not understand whether two requests are associated with one another until after an identified association(s) is confirmed by the relevant client terminals. Receiving multiple requests, sever 130 may coarsely select candidate requests, e.g., those close to one another in relevant geographic positions and timing, and do the matching.

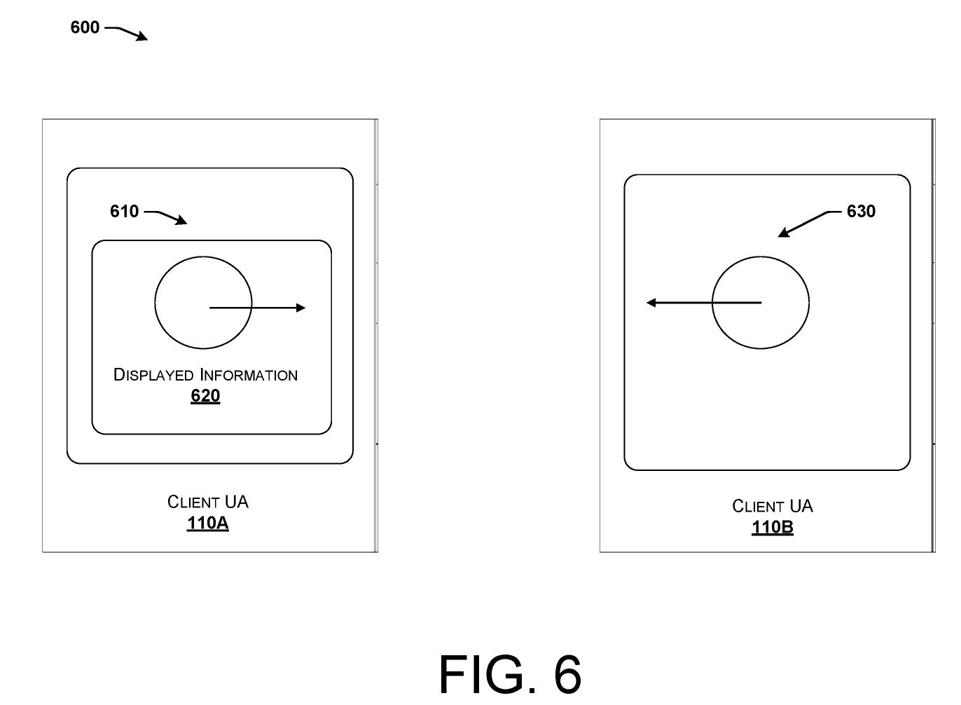

Matching units 232 may further match the candidate requests based on geographic pointers, reference position estimates and/or time stamps. For example, a reference position estimate contained in the initiative request may be matched with a reference position estimate contained in the responsive request. As shown in example input scenarios of FIG. 6, with respect to the initiative request, gesture input 610 on client terminal 110A points to a displayed information 620 and swings to the straight right of client terminal 110A, i.e., a relative direction. With respect to the responsive request, gesture input 630 swings to the straight left of client terminal 110B, i.e., a relative direction. With the respective geographic positions of client terminals 110A, 110B determined, matching unit 232 may match the two identified relative directions (which point to one another) and determine that client terminals 110A and 110B are associated in the same requested content sharing.

In example operation 430, CT association determination unit 226 may also send the determined association (potential/candidate association) to at least one of the requesting client terminal 110A and associated client terminal 110B (with respect to the initiative request of client terminal 110A) for them to confirm that they are willing to conduct the requested content sharing with one another. In an example, CT association determination unit 226 may cause to activate a modal dialog with at least one of client terminal 110A and client terminal 110B configured for them to confirm the requested information sharing. In an example, the confirmation from associated client terminal 110B may be treated as a responsive request.

In example operation 440, sharing implementation unit 234 may implement an information/content sharing session between requesting client terminal 110A and associated client terminal 110B. Specifically, in example sub-operation 442, information identification unit 236 may identify the to-be-shared content/information based on at least one of the initiative request from client terminal 110A or the responsive request including the confirmation from associated client terminal 110B.

Upon identifying the to-be-shared information, sharing implementation unit 234 may coordinate with sharing coordination unit 330 of client terminal 110B to implement the sharing. For illustrative example, sharing implementation unit 234 may send a URL link of the content/information 630 displayed on client terminal 110A to client terminal 110B and sharing coordination unit 330 of client terminal 110B may display the same content 630 as displayed on client terminal 110A.

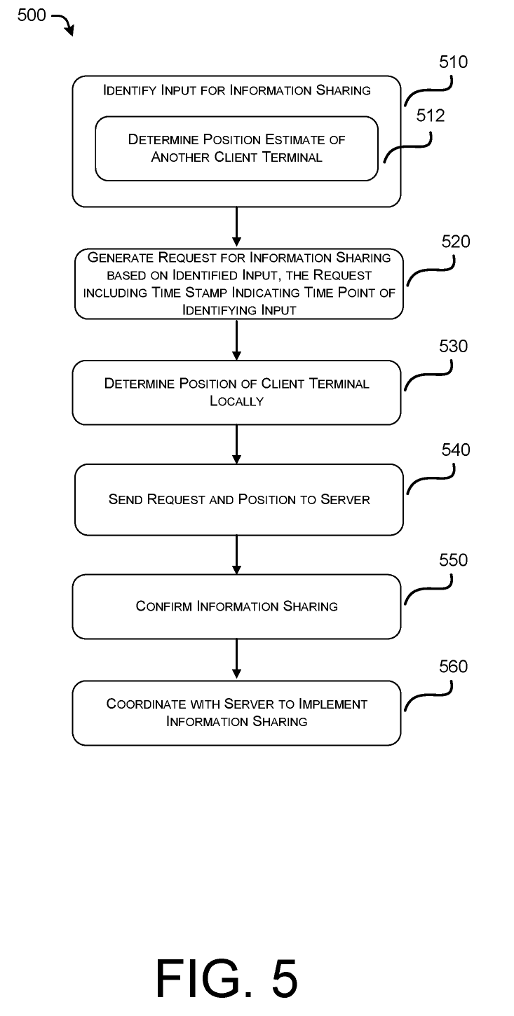

FIG. 5 shows an example operation process of a client terminal 110. In the description of FIG. 5, example scenarios of client terminal 110A being a requesting client terminal of an initiative request (e.g., a request of an earlier time stamp) to receive a shared content is used as an illustrative example. Other scenarios are appreciable and included in the disclosure.

Referring to FIG. 5, in example operation 510, input detection unit 322 of requesting client terminal 110A may identify an input for initiating information sharing. Specifically, in example sub-operation 512, position estimation unit 324 may determine, from the identified input, a reference position estimate of associated client terminal 110B that is supposed to share the content in the requested content sharing.

In example operation 520, request generation unit 326 may generate, based on the identified input, a request for information sharing. The request for information sharing may include a time stamp indicating a time point of identifying the input and may include the determined reference position estimate of associated client terminal 110B.

In example operation 530, local position determination unit 328 may determine a geographic position of client terminal 110A within a first time range about the time stamp of the generated request. The determined geographic position of client terminal 110A may be included in the generated request or may be sent to server 130 separately than the request.

In example operation 540, the generated request may be sent to server 130 through a communication channel.

In example operation 550, a confirmation to conduct content/information sharing with associated client terminal 110B may be sent to server 130.

In example operation 560, sharing coordination unit 330 may coordinate with server 130 to implement information sharing. Specifically, for example, sharing coordination unit 330 may identify the content/information provided by server 130 for the content sharing and display the content/information on client terminal 110B.

By means of the examples of the present disclosure, an association relationship between client terminals may be established based on the client terminal associated to one another in temporal and spatial dimensions. Therefore, sharing information between the client terminals may be conducted based on the established association relationship. As such, sharing of information may be implemented more conveniently and efficiently without using any instant communication tool and regardless of whether the users/client terminals have any preexisting relationship.

### 4. Conclusion

The present disclosure may include the following solutions:

A business object information sharing method, including: a server receiving a sharing initiation request sent by a first client terminal, the sharing initiation request being sent by the first client terminal when detecting a first triggering operation, and carrying identification information of a to-be-shared target business object; determining first positioning information of a first terminal device where the first client terminal is located, and determining positioning information of another terminal device in a time range; determining, according to the first positioning information and the positioning information of another terminal device, a second terminal device that is associated with the first terminal device in temporal and spatial dimensions; and determining to-be-shared information according to the identification information of the target business object, and sending the to-be-shared information to the second terminal device, such that the second client terminal provides the to-be-shared information.

A business object information sharing method, including: a first client terminal receiving a first triggering operation for generating a sharing initiation request; determining identification information of a to-be-shared target business object; and generating a sharing initiation request and sending the sharing initiation request to a server, wherein the sharing initiation request carries the identification information of the target business object, such that the server determines, according to first positioning information of a first terminal device where the first client terminal is located and positioning information of another terminal device in a preset time range, a second terminal device that is associated with the first terminal device in temporal and spatial dimensions, and sends the identification information of the target business object to the second terminal device.

A business object information sharing method, including: a second client terminal receiving a second triggering operation for generating a sharing reception request; determining second positioning information of a second terminal device where the second client terminal is located; generating a sharing reception request and sending the sharing reception request to a server, wherein the sharing reception request carries the second positioning information and second time information, such that the server determines, according to the second positioning information, the second time information, as well as positioning information and time information of another terminal device carried in the sharing initiation request, a first terminal device that is associated with the second terminal device, determines to-be-shared information according to identification information of a target business object carried in the corresponding sharing initiation request, and sends the to-be-shared information to the second terminal device; and providing response information according to the to-be-shared information sent by the server.

A business object information sharing apparatus is applicable to a server, and the apparatus includes: a sharing initiation request receiving unit configured to receive a sharing initiation request sent by a first client terminal, where the sharing initiation request is sent by the first client terminal when detecting a first triggering operation, and carries identification information of a to-be-shared target business object; an information determination unit configured to determine first positioning information of a first terminal device where the first client terminal is located, and determine positioning information of another terminal device in a time range; an association relationship determination unit configured to determine, according to the first positioning information and the positioning information of another terminal device, a second terminal device that is associated with the first terminal device in temporal and spatial dimensions; and a shared information providing unit configured to determine to-be-shared information according to the identification information of the target business object, and send the to-be-shared information to the second terminal device, such that the second client terminal provides the to-be-shared information.

A business object information sharing apparatus is applicable to a first client terminal, and includes: a first triggering operation receiving unit configured to receive a first triggering operation for generating a sharing initiation request; an identification information determination unit configured to determine identification information of a to-be-shared target business object; and a sharing initiation request generation unit configured to generate a sharing initiation request and send the sharing initiation request to a server, wherein the sharing initiation request carries the identification information of the target business object, such that the server determines, according to first positioning information of a first terminal device where the first client terminal is located and positioning information of another terminal device in a preset time range, a second terminal device that is associated with the first terminal device in temporal and spatial dimensions, and sends the identification information of the target business object to the second terminal device.

A business object information sharing apparatus includes: a second triggering operation receiving unit configured to receive a second triggering operation for generating a sharing reception request; a second positioning information determination unit configured to determine second positioning information of a second terminal device where the second client terminal is located; a sharing reception request generation unit configured to generate a sharing reception request and send the sharing reception request to a server, wherein the sharing reception request carries the second positioning information and second time information, such that the server determines, according to the second positioning information, the second time information, as well as positioning information and time information of another terminal device carried in the sharing initiation request, a first terminal device that is associated with the second terminal device, determines to-be-shared information according to identification information of a target business object carried in the corresponding sharing initiation request, and sends the to-be-shared information to the second terminal device; and a response information providing unit configured to provide response information according to the to-be-shared information sent by the server.

Through the description of the foregoing implementations, those skilled in the art can clearly understand that the present application can be implemented by software plus a necessary universal hardware platform. Based on such understanding, the technical solution of the present application may be embodied in the form of a software product. The software product may be stored in a storage medium, such as a ROM/RAM, a magnetic disk, or an optical disc, and include several instructions that enable a computer device (which may be a personal computer, a server, or a network device) to execute the methods in the embodiments or certain portions of the embodiments of the present application.

Various embodiments in the specification are described in a progressive manner. The same or similar parts between the embodiments may be referenced to one another. In each embodiment, the portion that is different from other embodiments is emphasized and described. Especially, the system or system embodiment is described relatively simply because it is substantially similar to the method embodiment, and for the relevant part, reference may be made to the descriptions of the method embodiment. The system and system embodiment described above are merely exemplary, wherein units described as separate parts may be or may not be physically separate, parts displayed as units may be or may not be physical units, and they may be located at the same place, or be distributed to multiple network units. The objective of the solution of this embodiment may be implemented by selecting some of or all modules according to actual requirements. Those of ordinary skill in the art may understand and implement the present application without creative efforts.

The disclosure may be further understood with the following clauses:

Clause 1: an information sharing method, comprising: a server receiving a sharing initiation request sent by a first client terminal, wherein the sharing initiation request is sent by the first client terminal when detecting a first triggering operation, and carries identification information of a to-be-shared target information; determining first positioning information of a first terminal device where the first client terminal is located, and determining positioning information of another terminal device in a preset time range; determining, according to the first positioning information and the positioning information of another terminal device, a second terminal device that is associated with the first terminal device in temporal and spatial dimensions; and determining to-be-shared information according to the identification information of the target information, and sending the to-be-shared information to the second terminal device, such that the second client terminal provides the to-be-shared information.

Clause 2: the method of clause 1, wherein the sharing initiation request further includes the first positioning information and first time information of the first terminal device where the first client terminal is located; the determining first positioning information of a first terminal device where the first client terminal is located comprises: extracting the first positioning information from the sharing initiation request; the determining positioning information of another terminal device in a preset time range comprises: receiving a sharing reception request sent by a second client terminal, wherein the sharing reception request is sent by the second client terminal when detecting a second triggering operation, and carries second positioning information and second time information of a second terminal device where the second client terminal is located; and the determining, according to the first positioning information and the positioning information of another terminal device, a second terminal device that is associated with the first terminal device in temporal and spatial dimensions comprises: judging whether the first positioning information and the second positioning information as well as the first time information and the second time information meet a preset condition; and if yes, determining that the second terminal device is associated with the first terminal device.

Clause 3: the method of clause 2, wherein the sharing initiation request further includes orientation direction information of the first triggering operation; and the judging whether the first positioning information and the second positioning information meet a preset condition comprises: judging, according to the first positioning information and the second positioning information, whether a distance to the second terminal device meets a preset condition, and whether a position of the second terminal device relative to the first terminal device is in the orientation direction of the first triggering operation.

Clause 4: an information sharing method, comprising: a first client terminal receiving a first triggering operation for generating a sharing initiation request; determining identification information of a to-be-shared target information; and generating a sharing initiation request and sending the sharing initiation request to a server, wherein the sharing initiation request carries the identification information of the target information, such that the server determines, according to first positioning information of a first terminal device where the first client terminal is located and positioning information of another terminal device in a preset time range, a second terminal device that is associated with the first terminal device in temporal and spatial dimensions, and sends the identification information of the target information to the second terminal device.

Clause 5: the method of clause 4, further comprising: determining current first positioning information of the first terminal device where the first client terminal is located, and adding the first positioning information and time information to the sharing initiation request, such that the server extracts, from the sharing initiation request, the first positioning information and shares the first positioning information to the terminal device.

Clause 6: the method of clause 5, further comprising: determining an orientation direction of the first triggering operation, and adding information of the orientation direction to the sharing initiation request, such that the server judges an association relationship between the terminal devices according to the information of the orientation direction.

Clause 7: the method of clause 4, wherein a first client terminal receiving a first triggering operation for generating a sharing initiation request comprises: detecting a first triggering operation; determining, when the first triggering operation is detected, content displayed on a current page; and determining, if the current page is used for displaying information of a specific information, that the first triggering operation is used for generating a sharing initiation request; and the determining identification information of a to-be-shared target information comprises: determining the specific information displayed on the current page as the target information, and determining identification information of the target information.

Clause 8: the method of clause 7, further comprising: displaying, according to a trace of the first triggering operation, an animation effect that the current page is moved out of a screen.

Clause 9: an information sharing method, comprising: a second client terminal receiving a second triggering operation for generating a sharing reception request; determining second positioning information of a second terminal device where the second client terminal is located; generating a sharing reception request and sending the sharing reception request to a server, wherein the sharing reception request sends the second positioning information and second time information, such that the server determines, according to the second positioning information, the second time information, as well as positioning information and time information of another terminal device carried in the sharing initiation request, a first terminal device that is associated with the second terminal device, determines to-be-shared information according to identification information of a target information carried in the corresponding sharing initiation request, and sends the to-be-shared information to the second terminal device; and providing response information according to the to-be-shared information sent by the server.

Clause 10: the method of clause 9, further comprising: displaying, according to a trace of the second triggering operation, an animation effect that a shared user interface is moved into a screen.

Clause 11: an information sharing apparatus applicable to a server, the apparatus comprising: a sharing initiation request receiving unit configured to receive a sharing initiation request uploaded by a first client terminal, wherein the sharing initiation request is sent by the first client terminal when detecting a first triggering operation, and carries identification information of a to-be-shared target information; an information determination unit configured to determine first positioning information of a first terminal device where the first client terminal is located, and determine positioning information of another terminal device in a preset time range; an association relationship determination unit configured to determine, according to the first positioning information and the positioning information of another terminal device, a second terminal device that is associated with the first terminal device in temporal and spatial dimensions; and a shared information providing unit configured to determine to-be-shared information according to the identification information of the target information, and send the to-be-shared information to the second terminal device, such that the second client terminal provides the to-be-shared information.

Clause 12: the apparatus of clause 11, wherein the sharing initiation request further includes the first positioning information and first time information of a first terminal device where the first client terminal is located; the information determination unit comprises: a first extraction sub-unit configured to extract the first positioning information from the sharing initiation request; a second extraction sub-unit configured to receive a sharing reception request uploaded by a second client terminal, wherein the sharing reception request is sent by the second client terminal when detecting a second triggering operation, and carries second positioning information and second time information of a second terminal device where the second client terminal is located; and the association relationship determination unit comprises: a judgment sub-unit configured to judge whether the first positioning information and the second positioning information as well as the first time information and the second time information meet a preset condition; and a determination sub-unit configured to, if the judgment result of the judgment subunit is positive, determine that the second terminal device is associated with the first terminal device.

Clause 13: the apparatus of clause 12, wherein the sharing initiation request further includes orientation direction information of the first triggering operation; and the judgment subunit is configured to: judge, according to the first positioning information and the second positioning information, whether a distance to the second terminal device meets a preset condition, and whether a position of the second terminal device relative to the first terminal device is in the orientation direction of the first triggering operation.

Clause 14: an information sharing apparatus applicable to a first client terminal, comprising: a first triggering operation receiving unit configured to receive a first triggering operation for generating a sharing initiation request; an identification information determination unit configured to determine identification information of a to-be-shared target information; and a sharing initiation request generation unit configured to generate a sharing initiation request and send the sharing initiation request to a server, wherein the sharing initiation request carries the identification information of the target information, such that the server determines, according to first positioning information of a first terminal device where the first client terminal is located and positioning information of another terminal device in a preset time range, a second terminal device that is associated with the first terminal device in temporal and spatial dimensions, and sends the identification information of the target information to the second terminal device.

Clause 15: the apparatus of clause 14, further comprising: a first positioning information determination unit configured to determine current first positioning information of the first terminal device where the first client terminal is located, and add the first positioning information and time information to the sharing initiation request, such that the server extracts, from the sharing initiation request, the first positioning information and shares the first positioning information to the terminal device.

Clause 16: the apparatus of clause 15, further comprising: an operation direction determination unit configured to determine an orientation direction of the first triggering operation, and add information of the orientation direction to the sharing initiation request, such that the server judges an association relationship between the terminal devices according to the information of the orientation direction.

Clause 17: the apparatus of clause 14, wherein the first triggering operation receiving unit comprises: a detection sub-unit configured to detect a first triggering operation; a page content determination sub-unit configured to determine, when the first triggering operation is detected, content displayed on a current page; and a page content judgment sub-unit configured to determine, if the current page is used for displaying information of a specific information, that the first triggering operation is used for generating a sharing initiation request; and the identification information determination unit is configured to: determine the specific information displayed on the current page as the target information, and determine identification information of the target information.

Clause 18: the apparatus of clause 17, further comprising: a first animation effect displaying unit configured to display, according to a trace of the first triggering operation, an animation effect that the current page is moved out of a screen.

Clause 19: an information sharing apparatus applicable to a second client terminal, comprising: a second triggering operation receiving unit configured to receive a second triggering operation for generating a sharing reception request; a second positioning information determination unit configured to determine second positioning information of a second terminal device where the second client terminal is located; a sharing reception request generation unit configured to generate a sharing reception request and send the sharing reception request to a server, wherein the sharing reception request carries the second positioning information and second time information, such that the server determines, according to the second positioning information, the second time information, as well as positioning information and time information of another terminal device carried in the sharing initiation request, a first terminal device that is associated with the second terminal device, determines to-be-shared information according to identification information of a target information carried in the corresponding sharing initiation request, and sends the to-be-shared information to the second terminal device; and a response information providing unit configured to provide response information according to the to-be-shared information sent by the server.

Clause 20: the apparatus of clause 19, further comprising: a second animation effect displaying unit configured to display, according to an execution trace of the second triggering operation, an animation effect that a shared user interface is moved into a screen.

1. A method, comprising:
at a server,
receiving a first request for information sharing from a first client terminal with a time stamp;
determining a geographic position of the first client terminal within a first time range about the time stamp of the first request;
identifying a second client terminal in a geographic proximity to the first client terminal within a second time range related to the time stamp of the first request; and
implementing an information sharing session between the first client terminal and the second client terminal based on the first request.

2. The method of claim 1, wherein the determining the geographic position of the first client terminal includes obtaining position information of the first client terminal from the first request.

3. The method of claim 1, wherein the determining the geographic position of the first client terminal is based on at least one of a satellite based positioning, a sensor based positioning and a radio frequency signal based positioning.

4. The method of claim 1, wherein the identifying the second client terminal in the geographic proximity to the first client terminal includes determining a geographic position of the second client terminal within the second time range about the time stamp of the first request based on a same positioning technology as the position of the first client terminal.

5. The method of claim 1, wherein the first request for information sharing further includes a reference position estimate of the second client terminal.

6. The method of claim 5, wherein the identifying the second client terminal is based, at least in part, on the reference position estimate of the second client terminal.

7. The method of claim 5, wherein the reference position estimate of the second client terminal includes a relative direction of the second client terminal with respect to the first client terminal.

8. The method of claim 1, wherein the implementing the information sharing session includes activating a dialog with at least one of the first client terminal and the second client terminal configured for the at least one of the first client terminal and the second client terminal to confirm the information sharing.

9. The method of claim 1, further comprising, at the server, receiving second request for information sharing from the second client terminal, the second request including a time stamp.

10. The method of claim 9, wherein the identifying the second client terminal in the geographic proximity to the first client terminal within the second time range about the time stamp of the first request includes matching the first request and the second request.

11. The method of claim 10, wherein the matching includes matching a reference position estimate contained in the first request with a reference position estimate contained in the second request.

12. The method of claim 1, wherein the first request includes identification information of a piece of information to be shared in the information sharing.

13. The method of claim 1, wherein the first time range and the second time range fully overlap with one another.

14. A method, comprising:
providing a server; and
providing, via a storage medium, a set of computer executable instructions configured to be installed on client devices, which, when executed by a processing unit of a client device, configure the processing unit to implement an information sharing client terminal;
wherein the information sharing client terminal is operable to:
identify an input for information sharing;
generate, based on the input, a request for the information sharing; and
sending the generated request to the server gesture; and
wherein the server is operable to:
receive the request with a time stamp,
determine a geographic position of the client terminal within a first time range about the time stamp of the request;
identify another client terminal in a geographic proximity to the information sharing client terminal within a second time range about the time stamp of the request; and
implement an information sharing session between the information sharing client terminal and the other client terminal based on the request.

15. The method of claim 14, wherein the identifying the input includes detecting a gesture operation identifying a piece of information displayed on the client device.

16. The method of claim 14, wherein the identifying the other client terminal in the geographic proximity to the information sharing client terminal within the second time range about the time stamp of the request includes:
determining a geographic position of the other client terminal within the second time range about the time stamp of the request; and
determining that the geographic position of the other client terminal is within a threshold distance from the geographic position of the information sharing client terminal.

17. The method of claim 14, wherein the request includes at least one of an identification of a piece of information available to the information sharing client terminal or an indication of receiving a piece of information under the information sharing.

18. The method of claim 14, wherein the generating the request for the information sharing includes generating the request including a reference position estimate of the other client terminal.

19. The method of claim 18, wherein the reference position estimate includes at least one of a relative direction or an estimated distance of the other client terminal with respect to the information sharing client terminal.

20. A computing system, comprising:
a communication element;
a processing unit; and
a storage device containing computer executable instruction which, when executed by the processing unit, configure the processing unit to effectuate operations including:
receiving a request for information sharing from a first client terminal;
determining a position of the first client terminal;
identifying a second client terminal in a geographic proximity to the first client terminal;
determining that at least one of the first client terminal and the second client terminal agree to conduct the information sharing between the first client terminal and the second client terminal; and
implementing an information sharing session between the first client terminal and the second client terminal based on the request.

21. (canceled)
